(19) United States
(12) Patent Application Publication
(10) Pub. No.: US 2021/0219562 A1
(43) Pub. Date: Jul. 22, 2021

(54) SWEET POTATO CHEESECAKE

(71) Applicant: DELACEIA STOREY, SARASOTA, FL (US)

(72) Inventor: DELACEIA STOREY, SARASOTA, FL (US)

(21) Appl. No.: 17/222,203

(22) Filed: Apr. 5, 2021

(51) Int. Cl. A21D 13/80; A23L 27/10; A23L 19/10; A21D 10/04

(52) U.S. Cl. CPC A21D 13/80; A21D 10/04; A23L 19/105; A23L 27/10

(57) ABSTRACT

A ready-to-eat sweet potato cheesecake that includes 2-3 medium-sized sweet potatoes, 8 oz Philadelphia Cream Cheese (softened), ⅓ oz Aunt Jemima maple Syrup, ½ cup Light Brown Sugar, 1¾ cups of pureed sweet potatoes, 2 large eggs, ½ cup low-fat buttermilk, 2 tablespoons of corn starch, ½ teaspoon of grounded cinnamon, ¼ teaspoon of ground nutmeg, 7-8 ginger snaps, and one 9″ graham cracker crust.

### CROSS-REFERENCE TO RELATED APPLICATIONS

This application claims priority to the U.S. provisional patent application serial number filed 62/995,587, filed on Feb. 5, 2020, which is incorporated herein by reference in its entirety.

### FIELD OF INVENTION

The present invention relates to a food recipe and more particularly, the present invention relates to a recipe for a potato cheesecake.

### BACKGROUND

Food is essential for life and eating healthy and tasty food promotes the health of the body and mind. However, due to a busy work schedule, people often do not have time to make food or a variety of foods. Thus, ready-to-eat foods are becoming popular that can be consumed directly or can be prepared in a few minutes.

Therefore, it is desirable to have a healthier and tastier food products in ready-to-eat form.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a ready-to-eat food product that is both healthy and tastier.

It is another object of the present invention that the food product is scrumptious.

It is still another object of the present invention that the food product is not fattening.

In one aspect, disclosed is a ready-to-eat food product that includes 2-3 medium-sized sweet potatoes, 8 oz Philadelphia Cream Cheese (softened), ⅓ oz Aunt Jemima maple Syrup, ½ cup Light Brown Sugar, 1% cups of pureed sweet potatoes, 2 large eggs, ½ cup low-fat buttermilk, 2 tablespoons of corn starch, ½ teaspoon of grounded cinnamon, ¼ teaspoon of ground nutmeg, 7-8 ginger snaps, and one 9″ graham cracker crust.

In one aspect, disclosed is a method of preparing the foodstuff, the method includes the steps of boiling sweet potatoes for a predetermined duration. Thereafter, mixing 1¾ cups of pureed potatoes with ⅓ cup of the maple syrup, ½ teaspoon of grounded cinnamon, 2 large eggs, ¼ teaspoon of nutmeg, ½ cup buttermilk, cream cheese, brown sugar, a ginger snap, and 8 oz of softened cream cheese in a food processor. The ingredients can be blended and thereafter the mixture can be poured onto a 9″ graham cracker crust. Bake the mixture with the graham cracker crust at 350° F. for an hour. Finally, top the slightly cooled cheesecake with a mixture of ⅛ cup brown sugar, crumbled ginger snaps (6-8), and ½ cup chopped pecans.

### DETAILED DESCRIPTION

Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a food product in a ready-to-eat form that is both healthier and tasty. The foodstuff also referred herein as the “Sweet Potato Cheesecake”, is unique in flavor and delicious. The disclosed foodstuff is made from mashed sweet potatoes that helps to reduce excess body fat. Provided in ready-to-eat form in suitable packaging. The disclosed foodstuff can be served as a dessert without any preparatory steps, and scrumptious in taste. A user can enjoy the disclosed foodstuff anytime and quickly.

In one exemplary embodiment, the foodstuff includes 2-3 medium-sized sweet potatoes, 8 oz Philadelphia Cream Cheese (softened), ⅓ oz Aunt Jemima maple Syrup, ½ cup Light Brown Sugar, 1% cups of pureed sweet potatoes, 2 large eggs, ½ cup low-fat buttermilk, 2 tablespoons of corn starch, ½ teaspoon of grounded cinnamon, ¼ teaspoon of ground nutmeg, 7-8 ginger snaps, and one 9″ graham cracker crust.

In one exemplary embodiment, the disclosed is a method of preparing the Sweet Potato Cheesecake. The method includes the steps of:
Boiling sweet potatoes in water,
Mashing the boiled potatoes to form a puree;
Mixing, 1% cups of pureed potatoes, ½ cup of maple syrup, ½ teaspoon of grounded cinnamon, 2 large eggs, ¼ teaspoon of nutmeg, ½ cup buttermilk, cream cheese, brown sugar, a ginger snap, and 8 oz of softened cream cheese in a food processor to obtain a mix;
Blending the mix to obtains a pourable mixture;
Pouring mixture onto a 9″ graham cracker crust;
Baking the mixture onto a graham cracker crust at 350° F. for an hour; and
Finally, topping the slightly cooled cheesecake with a mixture of ⅛ cup brown sugar, crumbled ginger snaps (6-8), and ½ cup chopped pecans.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method of preparing a sweet potato cheesecake, in a ready-to-eat form, the method comprising the steps of:
boiling a predetermined quantity of sweet potatoes in water,
mashing the boiled potatoes to obtain a puree;
mixing, the pureed potatoes, maple syrup, grounded cinnamon, eggs, powdered nutmeg, buttermilk, cream cheese, brown sugar, ginger snap, and softened cream cheese in a food processor to obtain a mix;
blending the mix to obtains a pourable mixture;
pouring the mixture onto a graham cracker crust;
baking the mixture onto the graham cracker crust at 350° F. for an hour to obtain a baked product; and
adding a mixture of brown sugar, crumbled ginger snaps, and chopped pecans on the top of the baked product.

2. The method according to claim 1, wherein ingredients are present in the following proportion:
pureed potatoes: 1¾ cup, the cup having 240 ml volume capacity;
maple syrup: ⅓ cup;
grounded cinnamon: ½ teaspoon;
eggs: two in number;
powdered nutmeg: ¼ teaspoon;
buttermilk: ½ cup;
brown sugar: ½ cup; and
softened cream cheese: 8 oz.

3. The method according to claim 2, wherein the graham cracker crust is having a diameter of about 9 inches.

4. The method according to claim 2, wherein ½ cup of chopped pecans is added.
